(19) United States
(12) Patent Application Publication
(10) Pub. No.: US 2010/0093341 A1
(43) Pub. Date: Apr. 15, 2010

(54) METHOD AND DEVICE FOR REDIRECTING

(75) Inventor: Yinghui YU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/640,847

(22) Filed: Dec. 17, 2009

Related U.S. Application Data
(63) Continuation of application No. PCT/CN2008/071266, filed on Jun. 11, 2008.

(30) Foreign Application Priority Data
Jun. 18, 2007 (CN) 200710112781.3

(51) Int. Cl. H04W 4/00; H04M 1/00

(52) U.S. Cl. 455/426.1; 455/550.1

(57) ABSTRACT

A method and a device for redirecting are disclosed herein. The method for redirecting includes: obtaining, by a UE, redirection information carried in a paging message from a network; and performing redirection according to the redirection information. Another method for redirecting disclosed herein includes: by a UE, obtaining information about relation between the network capability information and information of service required by the UE, which is sent by the network through a paging message; and initiating redirection according to the obtained information about relation between network capability information and information of service required by the UE. Through the embodiments of the present invention, the time of setting up a call of a user is shortened, signaling impact caused by a user's paging response on the network is avoided, and a called UE is redirected.

### CROSS-REFERENCE TO RELATED APPLICATIONS

This application is a continuation of International Patent Application No. PCT/CN2008/071266, filed Jun. 11, 2008, which claims priority to Chinese Patent Application No. 200710112781.3, filed Jun. 18, 2007, both of which are hereby incorporated by reference in their entireties.

### FIELD OF THE INVENTION

The present invention relates to network communication, and in particular, to a method and a device for redirecting.

### BACKGROUND

In the Universal Mobile Telecommunications System (UMTS), paging messages are routed from a core network to an access network, and finally to a User Equipment (UE). The process of delivering a paging message includes two parts: transmission from the core network to the access network, and transmission from the access network to the UE. Two types of paging messages, paging type 1 and paging type 2, exist at the access network. Paging type 1 is transmitted on a paging channel. The functions of paging type 1 are to: page an idle UE, page a single active UE, release a single active UE, release a group of Radio Resources Control (RRC) connections, indicate change of a broadcast message, and page one or more active UEs or one or more idle UEs in one paging message. The functions of paging type 2 are to: page a connected UE or a UE group. Paging type 2 is transmitted on a Dedicated Control Channel (DCCH), namely, on an RRC dedicated channel.

As shown in FIG. 1, a process of redirecting a UE in the conventional art includes the following steps:

In step 11: The UE receives a paging message, namely, the UE is called.

In step 12: The UE sends an RRC connection request as a paging response to a network.

In step 13: The network redirects the UE according to the load information of the network, and sends redirection information in an RRC rejection message to the UE.

In the process of working out the present invention, the inventor finds at least the following defects in the method for redirecting the UE in the conventional art:

The called UE is redirected in the RRC connection rejection message, thus taking a long time for the UE to set up a call; and the UE needs to send an RRC connection setup request when the UE is redirected by the network. The UE access leads to a waste of and an impact on the network resources, especially when the network is overloaded.

### SUMMARY

The embodiments of the present invention provide a method and a device for redirecting, so as to shorten the time of setting up a call of a user, avoid signaling impact caused by the user's paging response on the network, and redirect a called UE.

The objectives of the embodiments of the present invention are fulfilled through the following technical solution.

A method for redirecting includes: (1) obtaining, by a UE, redirection information carried in a paging message from a network; and (2) performing, by the UE, redirection according to the obtained redirection information.

A method for redirecting includes: (1) obtaining, by a UE, information about relation between network capability information and information of service required by the UE, which is carried in a paging message from a network; and (2) performing, by the UE, redirection according to the obtained information about relation between network capability information and information of service required by the UE.

A network device includes: (1) a first module, configured to obtain redirection information required by a user equipment (UE) for performing redirection, or configured to obtain information about relation, between information of service required by the UE and network capability information, required by the UE for performing redirection; and (2) a redirecting information sending module, configured to send a paging message to the UE, wherein the paging message carries the obtained redirection information and the obtained information about relation.

A UE includes: (1) a fourth module, configured to receive a paging message from a network and obtain redirection information and information about relation, between information of service required by the UE and network capability information, from the paging message; and (2) a fifth module, configured to perform redirection according to the obtained redirection information and the obtained information about relation.

As seen from the technical solution according to the embodiments of the present invention, in the embodiments of the present invention, the paging message carries redirection indication information, or carries information about relation between network capability information and information about service required by a user. Therefore, the UE can be redirected according to the redirection indication information or the information about relation between network capability information and the information about service required by a user, the time of setting up a call of the user is shortened, and the signaling impact caused by the user's paging response on the network is avoided.

### BRIEF DESCRIPTION OF THE DRAWINGS

FIG. 1 is a flowchart of a method for redirecting a UE in the conventional art;

FIG. 2 is a flowchart of a method for redirecting according to an embodiment of the present invention;

FIG. 3 shows a schematic structure drawing of a network device for redirecting according to an embodiment of the present invention;

FIG. 4 shows a schematic structure drawing of a network device for redirecting according to another embodiment of the present invention;

FIG. 5 shows a schematic structure drawing of a UE for redirecting according to an embodiment of the present invention; and

FIG. 6 shows a schematic structure drawing of a UE for redirecting according to another embodiment of the present invention.

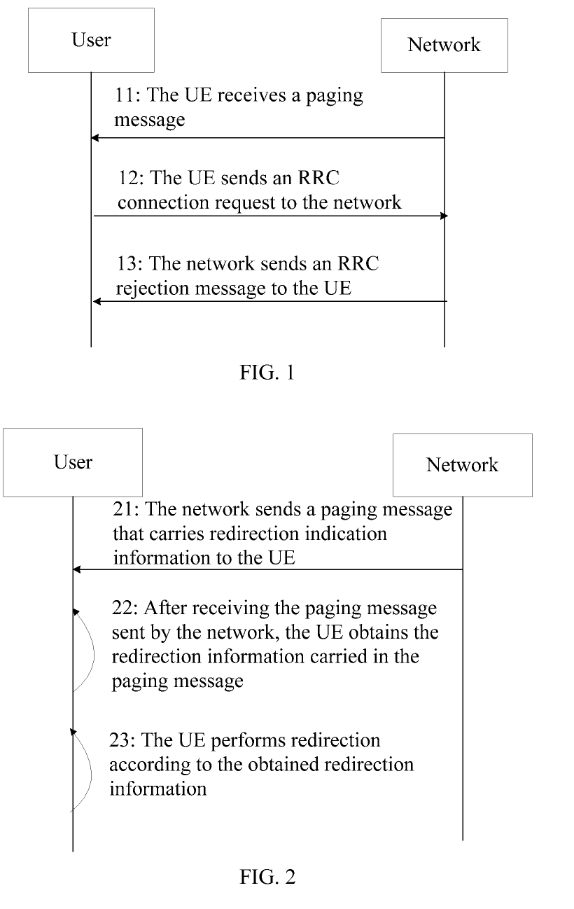

### DETAILED DESCRIPTION

The embodiments of the present invention provide a method and a device for redirecting. The redirection mentioned herein may be understood as a process of shifting the UE from one frequency to another frequency or shifting from one Radio Access Technology (RAT) to another RAT.

In the embodiments of the present invention, a paging message carries redirection information, or known as redirection indication information, or carries information about relation between network capability information and service information required by a user. The embodiments of the present invention are illustrated in detail below with reference to accompanying drawings. As shown in FIG. 2, the method according to an embodiment of the present invention includes the following steps:

In step 21: A network sends a paging message that carries redirection information to a UE.

When a core network sends a paging message to an access network, the access network decides whether to add the redirection information into the paging message according to load information of the access network, service capability information of the network, or network restriction information before forwarding the received paging message to the UE. The redirection information may include: cell information, cell set information, frequency information, or RAT information. Optionally, the redirection information may include the causes for redirection.

If redirection decision is based on the load information, the access network decides whether to send an indication of redirecting the UE according to the network load information. If redirection decision is based on the service capability information of the network, the network needs to compare service-related information of called party service with service capability of the network, and decides whether to send an indication of redirecting the UE according to the comparison result. If the network is under special access restriction, the network decides whether to send an indication of redirecting the UE according to the access restriction information. In practice, the access network may consider the load information, service capability information of the network, and network restriction information together in deciding whether to send an indication of redirecting the UE, namely, take these factors into consideration: the load information of the current network, service capability information of the network, network restriction information, and service-related information of the call party service.

The access network needs to determine redirection information of the UE if the network is overloaded, or the service capabilities of the network cannot support the called party service, or the called party is not allowed to access the network. Afterward, the access network adds the redirection information into a paging message, and sends the paging message to the UE.

Step 22: After receiving the paging message sent by the network, the UE obtains the redirection information carried in the paging message.

After receiving the paging message sent by the access network, the UE checks whether the paging message is intended for the UE. If the paging message is intended for the UE, the UE reads the paging message and obtains the redirection information carried in the paging message.

Step 23: The UE performs redirection according to the obtained redirection information.

The UE performs redirection operations, such as cell selection or cell reselection, according to the obtained redirection information. After the redirection is completed and the UE resides in a proper new cell, the UE may send a paging response message to the access network from the new cell.

In practice, the foregoing process may be improved. The improved process includes the following:

The network sends a paging message to the UE. The paging message carries information about relation between network capability information and information about service required by the UE. The network capability information includes at least one of these items: load information of the network, service capability information of the network, and restriction information of the network. The information about relation indicates whether the network is overloaded, whether the network service capabilities support the called party service, whether the called party is restricted from accessing the network, or whether comprehensive indication conditions fulfill the called party service.

After receiving the paging message sent by the network, the UE obtains the information about relation carried in the paging message, including: whether the network is overloaded, whether the network service capabilities support the called party service, whether the called party is restricted from accessing the network, or whether the comprehensive indication conditions fulfill the called party service. The UE decides whether to perform redirection according to the obtained information about relation.

Upon deciding to perform redirection, the UE performs redirection operations such as cell selection and cell reselection.

Three scenarios of applying the method according to the embodiment of the present invention are provided herein.

Scenario 1: An idle UE or UE group is redirected through a paging message.

The network adds a redirection-related Information Element (IE) into the IEs for the idle UE in the paging message. The added IE carries redirection indication information.

The IE of the paging record of paging type 1 in the UMTS protocol may be modified to the IE shown in Table 1.

TABLE 1
Modified IE of A Paging Record for an Idle UE

| Information | | | | | |
|---|---|---|---|---|---|
| Element/Group | | | Type and | Semantics | |
| name | Need | Multi | reference | description | Version |
| CHOICE Used | MP | | | | |
| paging identity | | | | | |
| >CN identity | | | | | |
| >>Paging cause | MP | | Paging cause | | |
| | | | 10.3.3.22 | | |
| >>CN domain | MP | | CN domain | | |
| identity | | | identity | | |
| | | | 10.3.1.1 | | |
| >>CHOICE UE | MP | | | Three spare | |
| Identity | | | | values are | |
| | | | | needed. | |
| >>>IMSI | | | IMSI | | |
| (GSM-MAP) | | | (GSM-MAP) | | |
| | | | 10.3.1.5 | | |
| >>>TMSI | | | TMSI | | |
| (GSM-MAP) | | | (GSM-MAP) | | |
| | | | 10.3.1.17 | | |
| >>>P-TMSI | | | P-TMSI | | |
| (GSM-MAP) | | | (GSM-MAP) | | |
| | | | 10.3.1.13 | | |
| >>>IMSI (DS-41) | | | TIA/EIA/IS- | | |
| | | | 2000-4 | | |
| >>>TMSI (DS-41) | | | TIA/EIA/IS- | | |
| | | | 2000-4 | | |
| (>UTRAN | | | | | |
| Information | | | | | |
| element) | | | | | |
| >>redirection info | OP | | 10.3.3.29 | | |
| >UTRAN single UE | | | | | |
| identity | | | | | |

In Table 1, the UTRAN information element is newly added and optional. The “redirection info” under “UTRAN Information element” in Table 1 is a newly added IE for representing the redirection indication information.

In a Long Term Evolution (LTE) system and a future access system, the redirection indication information message may be included in a root IE or child IE of the paging message.

The network sends the paging message to the UE, where the paging message carries the IE which includes the redirection indication information. The UE obtains the redirection indication information in the IE in the paging message, and performs corresponding redirection operations.

Scenario 2: A single active UE is redirected through a paging message.

The paging message of the UMTS includes the operation information for a single active UE. The active UE is in the URA_PCH, CELL_PCH, or CELL_FACH state. In this case, the paging message may be configured to release a single active UE.

In this scenario, the IE of the paging record for a single active UE is shown in Table 2.

TABLE 2
IE of a Paging Record for a Single Active UE

| Information | | | | | |
|---|---|---|---|---|---|
| Element/Group | | | Type and | Semantics | |
| name | Need | Multi | reference | description | Version |
| >UTRAN single UE | | | | | |
| identity | | | | | |
| >>U-RNTI | MP | | U-RNTI | | |
| | | | 10.3.3.47 | | |
| >>CN originated | OP | | | | |
| page to connected | | | | | |
| mode UE | | | | | |
| >>>Paging cause | MP | | Paging cause | | |
| | | | 10.3.3.22 | | |
| >>>CN domain | MP | | CN domain | | |
| identity | | | identity | | |
| | | | 10.3.1.1 | | |
| >>>Paging record | MP | | Paging record | | |
| type identifier | | | type identifier | | |
| | | | 10.3.1.10 | | |
| >>RRC connection | MP | | RRC connection | | REL-5 |
| release information | | | release | | |
| | | | information | | |
| | | | 10.3.3.35o | | |

Contents in the “RRC connection release information” in Table 2 are shown in Table 3.

TABLE 3
Contents of “RRC connection release information”

| Information | | | | | |
|---|---|---|---|---|---|
| Element/Group | | | Type and | Semantics | |
| name | Need | Multi | reference | description | Version |
| CHOICE Release | MD | | | Default value | REL-5 |
| indicator | | | | is “No release” | |
| >No release | | | | | REL-5 |
| >Release | | | | | REL-5 |
| >>Release cause | MP | | Release | | REL-5 |
| | | | cause | | |
| | | | 10.3.3.32 | | |
| Other information | | | | | |
| elements | | | | | |
| Redirection info | OP | | Redirection | | |
| | | | info | | |
| | | | 10.3.3.29 | | |

The “RRC connection release” IE in the paging record message is modified. Contents in the “Other information elements” IE and the “Redirection info” IE are newly added. The “Other information elements” IE in Table 3 are optional.

For a future communication systems such as LTE, the UE state is further simplified, and the URA_PCH state, the Cell_PCH state, and the Cell_FACH state no longer exist in the LTE system any more. In the future communication system, an active UE needs to be paged through a paging message. The redirection information may be carried in a root IE or child IE in the paging message.

Scenario 3: An active UE group is redirected through a paging message.

The paging message of the UMTS also includes the operation information for an active UE group. The active UE group is in the URA_PCH state, CELL_PCH state, or CELL_FACH state. In this case, the paging message may be configured to release an active UE group.

In this scenario, the IE of the paging record for an active UE group is shown in Table 4.

TABLE 4
IE of a Paging Record for an Active UE Group

| Information | | | | | |
|---|---|---|---|---|---|
| Element/Group | | | Type and | Semantics | |
| name | Need | Multi | reference | description | Version |
| CHOICE Release | MD | | | Default value | REL-5 |
| indicator | | | | is “No release” | |
| >No release | | | | | REL-5 |
| >Release | | | | | REL-5 |
| >>Release cause | MP | | Release | | REL-5 |
| | | | cause | | |
| | | | 10.3.3.32 | | |
| Other information | | | | | |
| elements | | | | | |
| Redirection info | OP | | Redirection | | |
| | | | info | | |
| | | | 10.3.3.29 | | |

Contents in the “RRC connection release information” in Table 4 are shown in Table 5.

TABLE 5
Contents of “RRC connection release information”

| Information | | | | | |
|---|---|---|---|---|---|
| Element/Group | | | Type and | Semantics | |
| name | Need | Multi | reference | description | Version |
| CHOICE Release | MD | | | Default value | REL-5 |
| indicator | | | | is “No release” | |
| >No release | | | | | REL-5 |
| >Release | | | | | REL-5 |
| >>Release cause | MP | | Release | | REL-5 |
| | | | cause | | |
| | | | 10.3.3.32 | | |
| Other information | | | | | |
| elements | | | | | |
| Redirection info | OP | | Redirection | | |
| | | | info | | |
| | | | 10.3.3.29 | | |

The “RRC connection release” IE in the paging record message is modified. Contents in the “Other information elements” IE and the “Redirection info” IE are newly added. The “Other information elements” IE in Table 5 are optional.

For a future communication systems such as LTE, the UE state is further simplified, and the URA_PCH state, the Cell_PCH state, and the Cell_FACH state no longer exist in the LTE system any more. In the future communication system, an active UE group needs to be paged through a paging message. The redirection information may be carried in a root IE or child IE in the paging message.

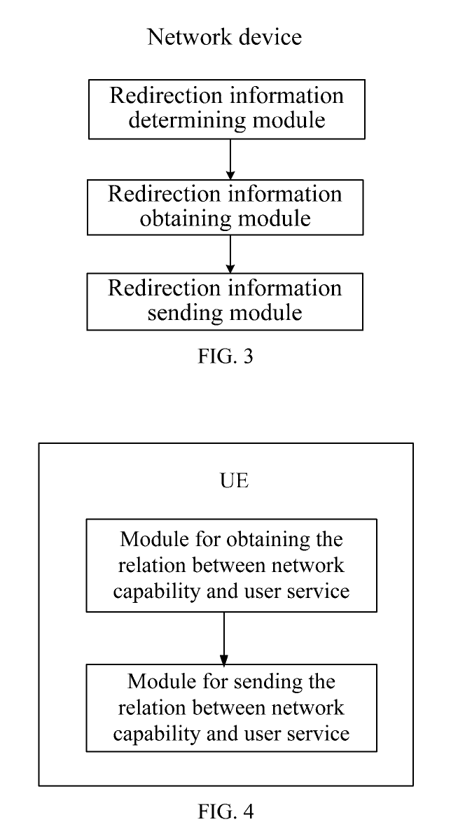

A system for redirecting according to an embodiment of the present invention includes a network device and a UE. As shown in FIG. 3, a network device according to an embodiment of the present invention includes: (1) a redirection information obtaining module, configured to obtain redirection information required by the UE for performing redirection; and (2) a redirection information sending module, configured to send a paging message to the UE, where the paging message carries the redirection information obtained by the redirection information obtaining module.

Optionally, the redirection information obtaining module obtains the redirection information from a redirection information determining module. The redirection information determining module is configured to sends an indication of redirecting the UE according to relation between network capability information and information of service required by the UE, and determine the corresponding redirection information.

As shown in FIG. 4, a network device according to another embodiment of the present invention includes: (1) a module for obtaining information about relation between network capability and user service, configured to obtain information about relation, between service required by the UE and network capability, required by the UE for performing redirection; and (2) a module for sending information about relation between network capability and user service, configured to send a paging message to the UE, where the paging message carries the information about relation between network capability and service required by the UE and the information about relation is obtained by the module for obtaining information of the relation between network capability and user service.

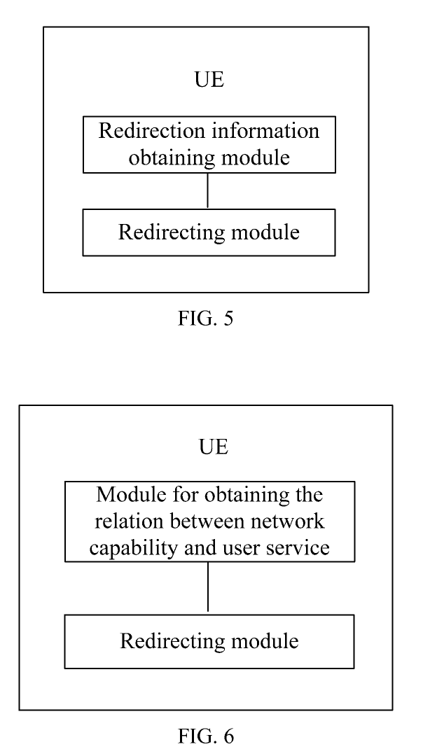

As shown in FIG. 5, a UE according to an embodiment of the present invention includes: (1) a redirection information obtaining module, configured to receive a paging message sent by the network and obtain the redirection information carried in the paging message; and (2) a redirecting module, configured to perform redirection according to the redirection information obtained by the redirection information obtaining module.

As shown in FIG. 6, a UE according to another embodiment of the present invention includes: (1) a module for obtaining information about relation between network capability and user service, configured to receive a paging message sent by the network, and obtain the information about relation between network capability and service required by the UE from the paging message; and (2) a redirecting module, configured to initiate redirection according to the information about relation obtained by the module for obtaining information about relation between network capability and user service.

In conclusion, in the embodiments of the present invention, a paging message carries redirection information of a called party; therefore, the called party is redirected. Not only an idle UE can be redirected, but also an active UE and UE group can be redirected.

In the embodiments of the present invention, a paging message carries the redirection information of a called party, and the UE performs redirection operations. Therefore, the delay of setting up a call of the UE is shortened, and, because no paging response needs to be sent to the network, access impact on the network is reduced and the network load is lightened.

Although the invention has been described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A method for redirecting, comprising:
obtaining, by a user equipment (UE), redirection information carried in a paging message from a network; and
performing, by the UE, redirection according to the obtained redirection information.

2. The method according to the claim 1, wherein the redirection information is determined according to information of service required by the UE and network capability information.

3. The method according to the claim 2, wherein the network capability information comprises at least one of the following items: load information of the network, service capability information of the network, and restriction information of the network.

4. The method according to the claim 2, further comprising:
sending a paging response to the network from a network to which the UE is redirected.

5. A method for redirecting, comprising:
obtaining, by a user equipment (UE), information about relation between information of service required by the UE and network capability information, which is carried in a paging message from a network side;
performing, by the UE, redirection according to the obtained information about relation between network capability information and information of service required by the UE.

6. The method according to claim 5, wherein the network capability information comprises at least one of the following items: load information of the network, service capability information of the network, and restriction information of the network.

7. The method according to claim 5, further comprising:
sending a paging response to the network side from a network to which the UE is redirected.

8. A network device, comprising:
a first module, configured to obtain redirection information or information about relation, between information of service required by the UE and network capability information, required by the UE for performing redirection; and
a second module, configured to send a paging message to the UE, wherein the paging message carries the obtained redirection information and the obtained information about relation.

9. The network device according to claim 8, further comprising:
a third module, configured to determine the redirection information according to network capability information and information of service required by the UE.

10. A user equipment (UE), comprising:
a fourth module, configured to receive a paging message from a network and obtain redirection information or information about relation, between information of service required by the UE and network capability information, from the paging message; and
a fifth module, configured to perform redirection according to the obtained redirection information and the obtained information about relation.
